(19) United States
(12) Patent Application Publication
(10) Pub. No.: US 2015/0212371 A1
(43) Pub. Date: Jul. 30, 2015

(54) LIGHT EMITTING APPARATUS, BACKLIGHT APPARATUS, AND DISPLAY APPARATUS

(71) Applicant: CANON KABUSHIKI KAISHA, Tokyo (JP)

(72) Inventor: Yasuhiro Matsuura, Yokohama-shi (JP)

(21) Appl. No.: 14/603,689

(22) Filed: Jan. 23, 2015

(30) Foreign Application Priority Data
Jan. 27, 2014 (JP) 2014-012642

(51) Int. Cl. G02F 1/1335

(52) U.S. Cl. CPC G02F 1/133609; G02F 1/133603; G02F 1/133514; G02F 1/133617

(57) ABSTRACT

A light emitting apparatus including a first and a second light source, wherein both light sources have spectral characteristics of blue light having an emission light peak within a first wavelength range, at least one of the light sources further has a spectral characteristic of at least one of green light having an emission light peak within a second wavelength range and red light having an emission light peak within a third wavelength range, and a composite spectral characteristic resulting from light emissions from the both light sources has peaks within the first, the second, and the third wavelength ranges, the peak within the first wavelength range has a larger half-value width than others, and the peak within the first wavelength range has a substantially symmetric shape about the peak wavelength.

### BACKGROUND OF THE INVENTION

1. Field of the Invention

The present invention relates to a light emitting apparatus, a backlight apparatus, and a display apparatus.

2. Description of the Related Art

In a backlight that uses a plurality of light sources such as light emitting diodes (hereinafter referred to as LEDs) which has a high color purity, color unevenness may occur in a surface of the backlight as a result of the adverse effect of a variation in wavelength among the light source.

Japanese Patent Application Laid-open No. 2011-40664 describes a backlight including at least one first white light source with a peak wavelength within a wavelength range equal to or smaller than a predetermined target wavelength and at least one second light source with a peak wavelength within a wavelength range larger than the target wavelength, the first and second white light sources being disposed in proximity to each other. The spectral characteristic of the white light sources allows peak wavelengths to be averaged near the target wavelength, enabling a reduction in the color unevenness in the surface of the backlight.

Japanese Patent Application Laid-open No. 2005-258248 describes a display apparatus including a first light source and a second light source having different light emitting wavelengths, means for converting a portion of light from the first light source, means for converting a portion of light from the second light source, and optical modulating means for modulating light intensity in accordance with image signals. Japanese Patent Application Laid-open No. 2005-258248 describes a technique for switching, when control is performed so as to form one image of a plurality of subimages, light emission between the first light source and the second light source in correspondence to the sub-images.

Japanese Patent Application Laid-open No. 2009-265135 describes a display apparatus including a first light source and a second light source having different light emitting wavelengths, a first subpixel, and a second subpixel. The first subpixel radiates a first color when irradiated with light by the first light source and radiates a second color when irradiated with light by the second light source. The second subpixel radiates a third color when irradiated with light by the second light source.

Japanese Patent Application Laid-open No. 2009-265135 describes a technique for alternately turning on a first light source and a second light source and independently controlling a first subpixel irradiated with light by the first light source and a second subpixel irradiated with light by the second light source.

### SUMMARY OF THE INVENTION

The technique disclosed in Japanese Patent Application Laid-open No. 2011-40664 is limited to LED light sources that emit white light and is not applicable to backlights with a wide color gamut. When the technique disclosed in Japanese Patent Application Laid-open No. 2011-40664 is applied to a backlight that uses monochromatic LEDs for red, green, and blue to mix the colors to emit white light, the use of the plurality of monochromatic light sources complicates a relevant control circuit. The techniques disclosed in Japanese Patent Application Laid-open Nos. 2005-258248 and 2009-265135 include simultaneous switching the states of liquid crystal color filters in connection with light emissions from the light sources. The techniques allow a wide color gamut to be achieved but involve complicated control.

This phenomenon is more significant when light sources such as LEDs which have a high color purity are used. On the other hand, the inventors have found that the spectral characteristic of white light has a peak in each color component such as red, green, or blue and that a high color purity is likely to lead to individual differences in the manner of sensing colors. Thus, disadvantageously, when a comparison is made between a wide-color-gamut backlight in which a defined white point is provided only by a white LED and a wide-color-gamut backlight in which the white point is provided by a red LED, a green LED, and a blue LED, individual differences in the manner of sensing colors are likely to occur in the latter wide-color-gamut backlight.

In contrast, the inventors have found that the individual differences in the manner of sensing colors can be suppressed by setting the spectral characteristic of a color component with a peak near 445 nm, included in the spectral characteristic of white light, to have a broad shape that is symmetric about the peak wavelength. That is, both the display in a wide color gamut and the reduction in the individual differences in the manner of viewing colors can be achieved by enabling only the spectral characteristic of a blue color component of a wide-color-gamut backlight to be broad and symmetric.

However, a configuration using one LED as a backlight light source has difficulty setting only the spectral characteristic of the blue color component, included in the spectral characteristic of white light, to be broad. In a configuration using, as a backlight light source, a plurality of LEDs such as a red LED, a green LED, and a blue LED which have different peak wavelengths, two types of blue LEDs need to be provided in order to set the spectral characteristic of the blue color component to have a broad shape. This leads to the need for at least light sources including a red LED, a green LED, a first blue LED, a second blue LED, resulting in to a complicated light source configuration or a complicated circuit configuration. The need is also not economically advantageous. Japanese Patent Application Laid-open No. 2009-265135 discloses a configuration that achieves three colors using two light sources but needs complicated control such as frame division and subpixel control.

With the above-described problems in view, it is an object of the present invention to provide a light emitting apparatus that achieves a wide color gamut and tends to suppress individual differences in the manner of sensing colors, while restraining the light source configuration and the control from being complicated.

An aspect of the present invention provides a light emitting apparatus including a first light source and a second light source,

in which both the first light source and the second light source have a spectral characteristic of blue light having an emission light peak or an excitation light peak within a predetermined first wavelength range,

at least one of the first light source and the second light source further has a spectral characteristic of at least one of green light having an emission light peak or an excitation light peak within a predetermined second wavelength range and red light having an emission light peak or an excitation light peak within a predetermined third wavelength range, and

a composite spectral characteristic resulting from light emissions from both the first light source and the second light source has peaks within the first wavelength range, within the second wavelength range, and within the third wavelength range, the peak within the first wavelength range has a larger half-value width than those of the peaks in the other wavelength ranges, and the peak within the first wavelength range has a substantially symmetric shape about the peak wavelength.

An aspect of the present invention can provide a light emitting apparatus that achieves a wide color gamut and tends to suppress individual differences in the manner of sensing colors, while restraining the light source configuration and the control from being complicated.

Further features of the present invention will become apparent from the following description of exemplary embodiments with reference to the attached drawings.

### BRIEF DESCRIPTION OF THE DRAWINGS

FIG. 1 is a block diagram depicting a general configuration of an image display apparatus according to an embodiment of the present invention;

FIG. 2 is a diagram depicting an arrangement example of light sources 11 and light sources 12 in a backlight according to the embodiment of the present invention;

FIG. 3 is a diagram depicting the spectral characteristics of the light source 11 and the light source 12 according to Embodiment 1;

FIG. 4 is a diagram of a spectral characteristic resulting from simultaneous light emission from the light source 11 and the light source 12 according to Embodiment 1;

FIG. 5 is a diagram depicting a spectral characteristic resulting from correction of a liquid crystal signal according to Embodiment 1;

FIG. 6 is a diagram depicting the spectral characteristics of a light source 11 and a light source 12 according to Embodiment 2;

FIG. 7 is a diagram of a spectral characteristic resulting from simultaneous light emission from the light source 11 and the light source 12 according to Embodiment 2;

FIG. 8 is a diagram depicting the spectral characteristics of a light source 11 and a light source 12 according to Embodiment 3; and

FIG. 9 is a diagram of a spectral characteristic resulting from simultaneous light emission from the light source 11 and the light source 12 according to Embodiment 3.

### DESCRIPTION OF THE EMBODIMENTS

### Embodiment 1

Embodiments of the present invention will be described with reference to the drawings. Embodiment 1 is characterized by a backlight including two types of LEDs as light sources to emit white light, in which the spectral characteristic of the white light has peaks for red, green, and blue and in which the spectral characteristic of blue has a broad shape that is linearly symmetric about a peak wavelength. Hereinafter, specific examples of implementation methods are explained.

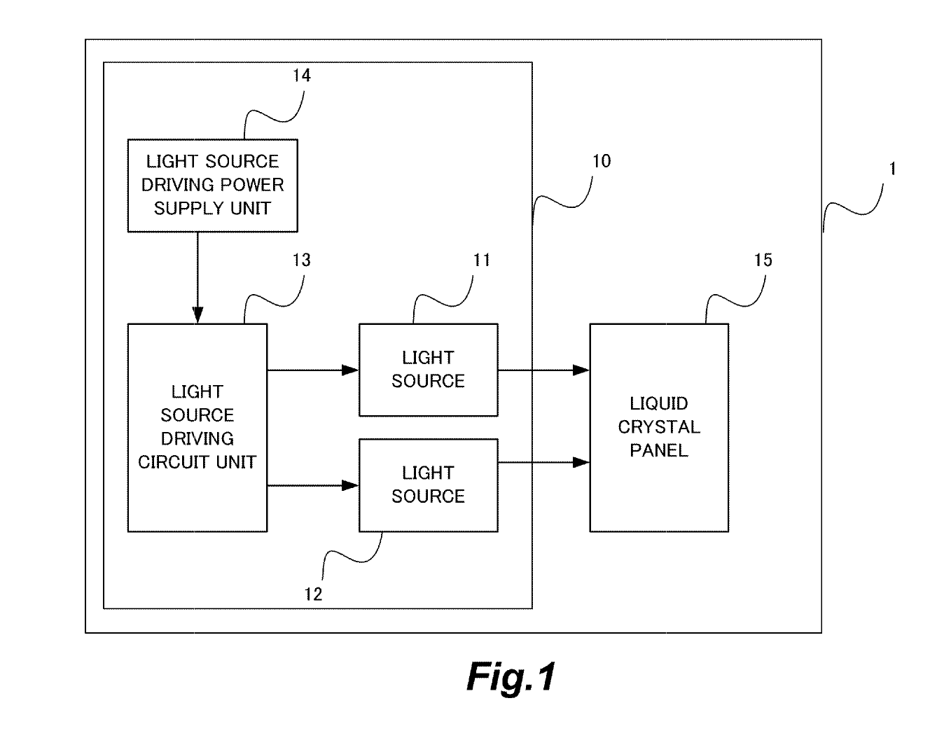

FIG. 1 is a block diagram depicting a general configuration of an image display apparatus according to Embodiment 1. An image display apparatus 1 has a backlight 10 and a liquid crystal panel 15. The backlight 10 has a light source 11 (first light source), a light source 12 (second light source), a light source driving circuit unit 13, and a light source driving power supply unit 14. Pixels in the liquid crystal panel 15 each have a blue color filter, a green color filter, and a red color filter. The transmittance of light from the backlight 10 is adjusted for each of the color filters to set transmitted light to be white light or allow an image to be displayed in accordance with an image signal.

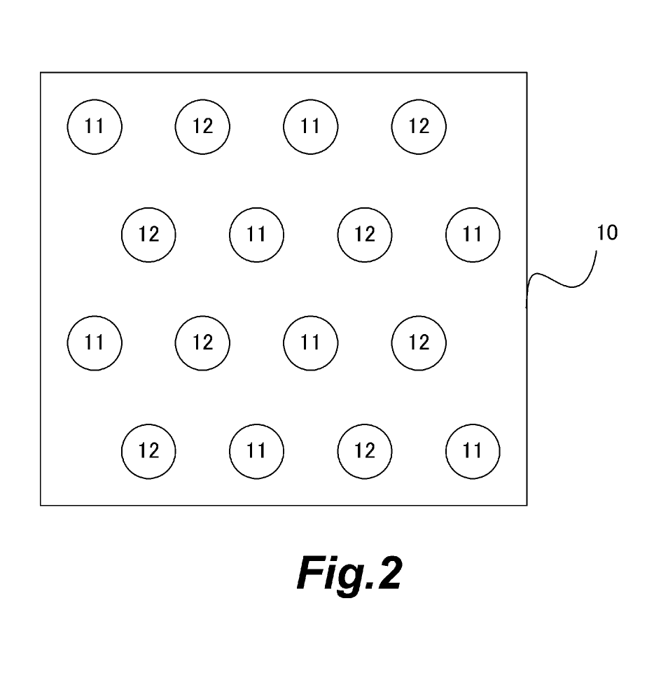

FIG. 2 is a diagram depicting an arrangement example of light sources 11 and light sources 12. As depicted in FIG. 2, in the backlight 10 according to Embodiment 1, light sources 11 and light source 12 are alternately arranged so as to facilitate mixture of light from the light sources. Disposition of the two types of light sources, the light sources 11 and the light sources 12 is not limited to the arrangement example depicted in FIG. 2.

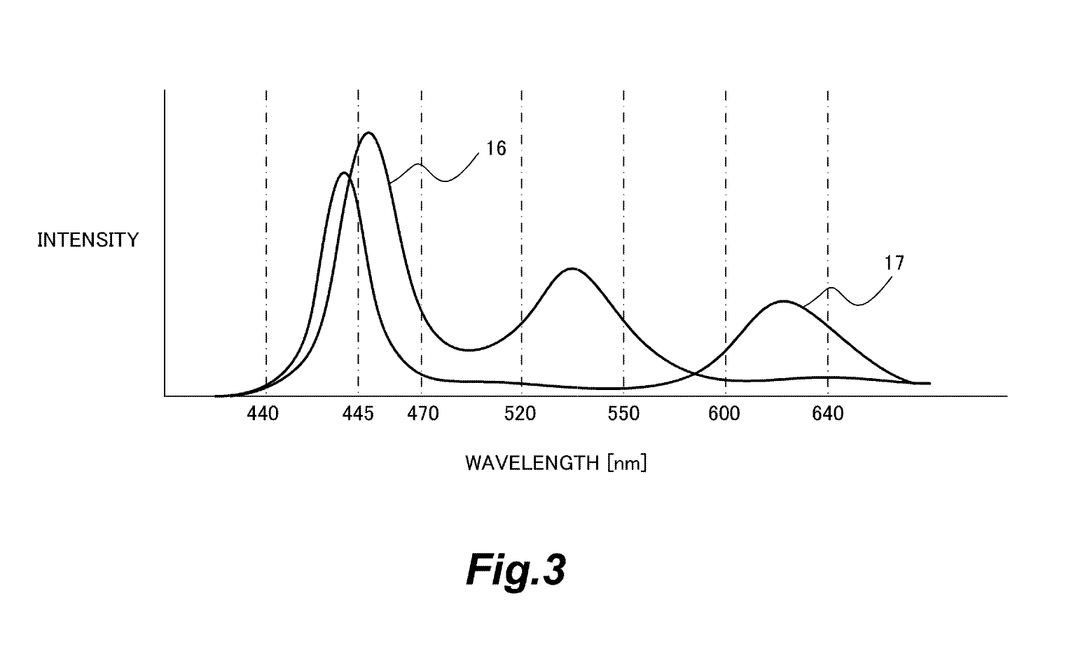

The spectral characteristics of the light source 11 and the light source 12 are depicted in FIG. 3. A spectral characteristic 16 in FIG. 3 is the spectral characteristic of the light source 11. A spectral characteristic 17 is the spectral characteristic of the light source 12. As depicted in FIG. 3, the light source 11 is a LED that emits blue light with a dominant wavelength within a predetermined first wavelength range (400 nm to 470 nm). The LED is assumed to excite green light with a dominant wavelength within a predetermined second wavelength range (520 nm to 550 nm). Like the light source 11, the light source 12 is also a LED that emits blue light with a dominant wavelength within the first wavelength range. However, the blue light emitted by the light source 12 is different, dominant wavelength, from the blue light emitted by the light source 11. The LED is assumed to excite red light with a dominant wavelength within a third wavelength range (600 nm to 640 nm).

The light source driving circuit unit 13 is a circuit that drives the light sources 11 and the light sources 12. The light source driving circuit unit 13 includes a constant current circuit and a pulse width control circuit to adjust currents passed to the light sources 11 and the light sources 12 and pulse widths so as to obtain the desired brightness(luminance) and white point.

The light source driving power supply unit 14 generates power needed to turn on the light sources 11 and the light sources 12 to supply the power to the light source driving circuit unit 13. A voltage generated by the light source driving power supply unit 14 is equal to or higher than a forward drop voltage for the light sources 11 and the light source 12.

The liquid crystal panel 15 displays an image in accordance with an image signal transmitted by an image output apparatus (not depicted in the drawings).

Now, the characteristics of the light sources 11 and the light sources 12 according to Embodiment 1 will be described.

Embodiment 1 is configured such that a spectral characteristic resulting from addition of the spectral characteristics of the light source 11 and the light source 12 within the first wavelength range has a larger half-value width than the spectral characteristic of the unitary light source 11 or the unitary light source 12. Moreover, a long wavelength side and a short wavelength side of the composite spectral characteristic are symmetric about the peak wavelength of the composite spectral characteristic. Furthermore, the composite spectral characteristic has a peak wavelength near 445 nm (for example, 445 nm±2 nm). The reason for the value near 445 nm is that the results of experiments indicate that individual differences in the manner of sensing colors are minimized when the spectral characteristic of a blue color component around 445 nm, included in the spectral characteristic of white light, has a broad shape.

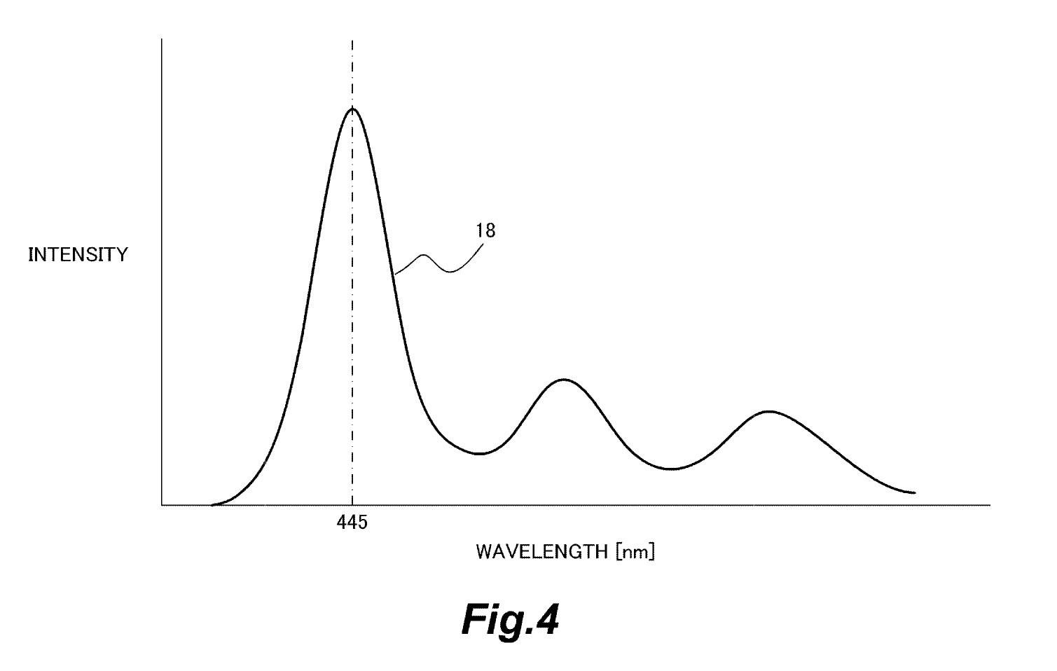

FIG. 4 depicts a spectral characteristic resulting from simultaneous light emissions from the light sources 11 and 12 configured as described above. As depicted in FIG. 4, a spectral characteristic 18 resulting from the simultaneous light emission is such that the long and short wavelength sides around the peak wavelength are symmetric near 445 nm. Such a spectral characteristic serves to provide a backlight with suppressed individual differences in the manner of sensing colors.

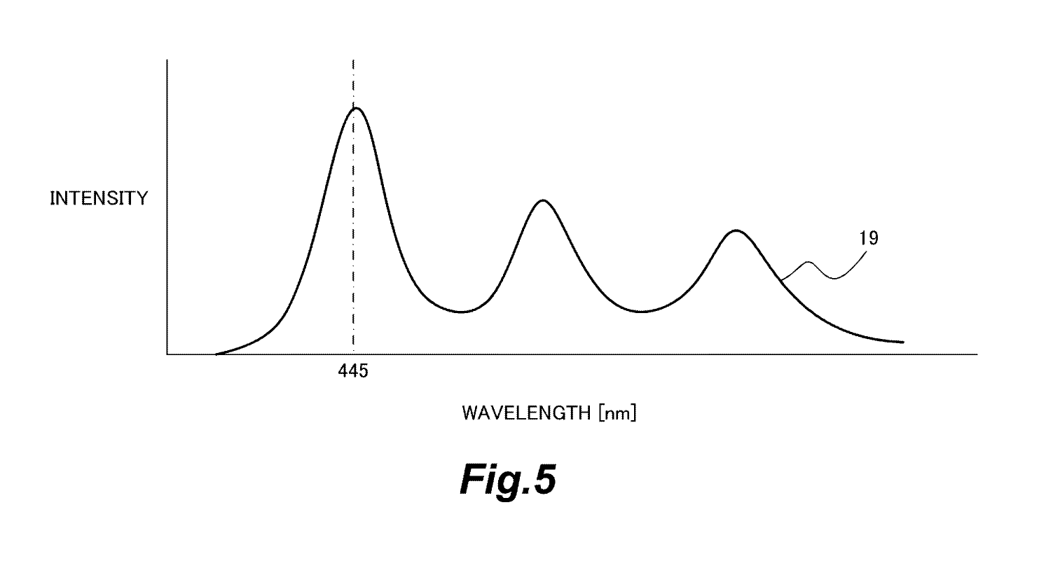

Signal processing on an image signal input to the liquid crystal panel 15 provides transmitted light from the color filter with such a spectral characteristic as depicted by a spectral characteristic 19 in FIG. 5. The signal processing allows a desired white point to be displayed.

In Embodiment 1, the configuration with only the two types of light sources, the light source 11 and the larger than 12, achieves a spectral characteristic having different peaks within the first wavelength range, within the second wavelength range, and within the third wavelength range, and in which only the peak at a wavelength of 445 nm within the first wavelength range exhibits the composite spectral characteristic of abroad and symmetric shape. The configuration allows implementation of a backlight including fewer light sources than a conventional backlight that uses three types of light sources including red LEDs, green LEDs, and blue LEDs but achieving both display in a wide color gamut and suppressed individual differences in the manner of viewing colors. Furthermore, the spectral characteristic of white light is obtained by simultaneously turning on the two types of light sources, the light sources 11 and the light sources 12. This eliminates the need for complicated control such as turn-on switching control of the light sources based on subframe division and switching control of a plurality of subpixels as in the conventional technique.

In Embodiment 1, the first light source 11 and the second light source 12 both have a spectral characteristic of blue light with an emission light peak or an excitation light peak within the first wavelength range and a spectral characteristic with an emission light peak or an excitation light peak within at least one of the second wavelength range and the third wavelength range. Specifically, the first light source 11 has an emission light peak within the first wavelength range and an excitation light peak in the second wavelength range. The second light source 12 has an emission light peak within the first wavelength range and an excitation light peak within the third wavelength range. The peak within the first wavelength range of the first light source 11 is different, in peak wavelength, from the peak within the first wavelength range of the second light source 12. One of the peaks has a wavelength on the longer wavelength side with respect to the peak wavelength (445 nm±2 nm). The other peak has a wavelength on the shorter wavelength side with respect to the peak wavelength. A composite spectral characteristic resulting from light emissions from the first light source 11 and the second light source 12 has peaks within the first wavelength range, within the second wavelength range, and within the third wavelength range. The peak within the first wavelength range has a larger half-value width than each of the peaks within the other wavelength ranges. Moreover, the peak within the first wavelength range has a substantially symmetric shape around the peak wavelength. The spectral characteristic within the first wavelength range can have a broad shape even in a configuration in which the peak within the first wavelength range of the first light source is substantially equal, in peak wavelength, to and is different, in half-value width, from the peak within the first wavelength range of the second light source.

### Embodiment 2

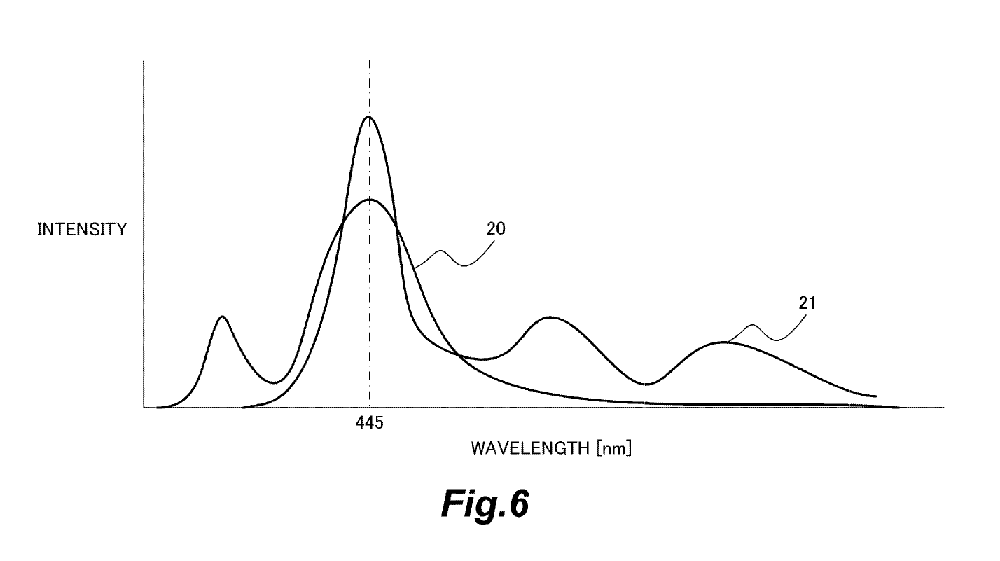

FIG. 6 is a diagram depicting a spectral characteristic 20 of a light source 11 and a spectral characteristic 21 of a light source 12 in a backlight according to Embodiment 2 of the present invention.

Embodiment 2 is similar, in the configuration of the light sources, to but is different, in the spectral characteristic of each light source, from Embodiment 1. As depicted in FIG. 6, the light source 11 is a LED that emits ultraviolet light with a dominant wavelength within a predetermined fourth wavelength range. The LED excites blue light with a dominant wavelength within a first wavelength range. Furthermore, the light source 12 is a LED that emits blue light with a dominant wavelength within a second wavelength range. The LED excites green light with a peak within the second wavelength range and red light with a peak within the third wavelength range. The LED excites red light with a dominant wavelength within a third wavelength range.

In Embodiment 2, the light source 11 is a LED that emits ultraviolet light with the dominant wavelength within the predetermined fourth wavelength range. The spectral characteristic of blue light excited by the LED has a peak wavelength near 445 nm. Furthermore, the light source 12 is a LED that emits blue light with the dominant wavelength within the first wavelength range, and has a peak wavelength near 445 nm.

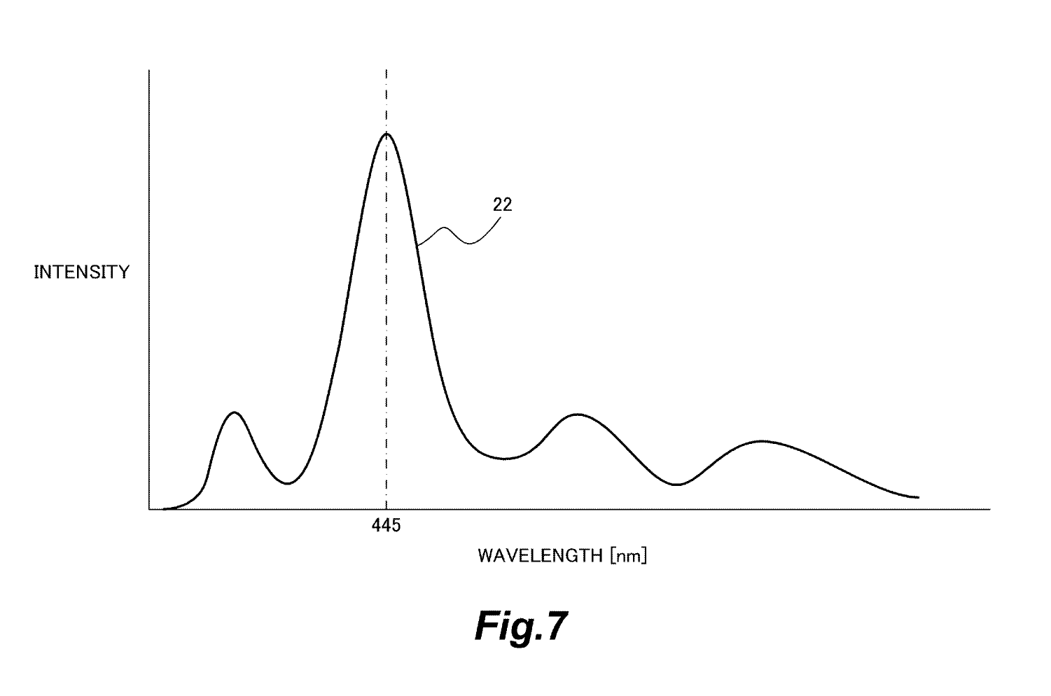

FIG. 7 depicts a composite spectral characteristic resulting from addition of the spectral characteristics of the light source 11 and the light source 12. As depicted in FIG. 7, in the composite spectral characteristic 22 resulting from addition of the spectral characteristics of the light source 11 and the light source 12, the spectral characteristic of blue has a broad and symmetric shape with a peak at 445 nm. This provides a backlight that suppresses individual distances in the manner of viewing colors.

The light source configuration in Embodiment 2 can make the spectral characteristic within the first wavelength range broader than the light source configuration in Embodiment 1. This enables further suppression of the differences in the manner of sensing colors.

In Embodiment 2, both the first light source 11 and the second light source 12 have a spectral characteristic with an emission light peak or an excitation light peak within the first wavelength range. The second light source 12 further has a spectral characteristic with an emission light peak or an excitation light peak within at least one of the second wavelength and the third wavelength range. Specifically, the first light source 11 has an emission light peak within the fourth wavelength range and an excitation light peak within the first wavelength range. The second light source 12 has an emission light peak within the first wavelength range and excitation light peaks within the second wavelength range and within the third wavelength range. The peak within the first wavelength range of the first light source 11 is substantially equal, in peak wavelength (445 nm±2 nm), to and is different, in half-value width, from the peak within the first wavelength range of the second light source 12. The composite spectral characteristic resulting from light emissions from the first light source 11 and the second light source 12 has peaks within the first wavelength range, within the second wavelength range, and within the third wavelength range. The peak within the first wavelength range has a larger half-value width than each of the peaks within the other wavelength ranges. Moreover, the peak within the first wavelength range has a substantially symmetric shape around the peak wavelength. The spectral characteristic within the first wavelength range can have a broad shape even in a configuration in which the peak within the first wavelength range of the first light source 11 and the peak within the first wavelength range of the second light source 12 have different peak wavelengths.

### Embodiment 3

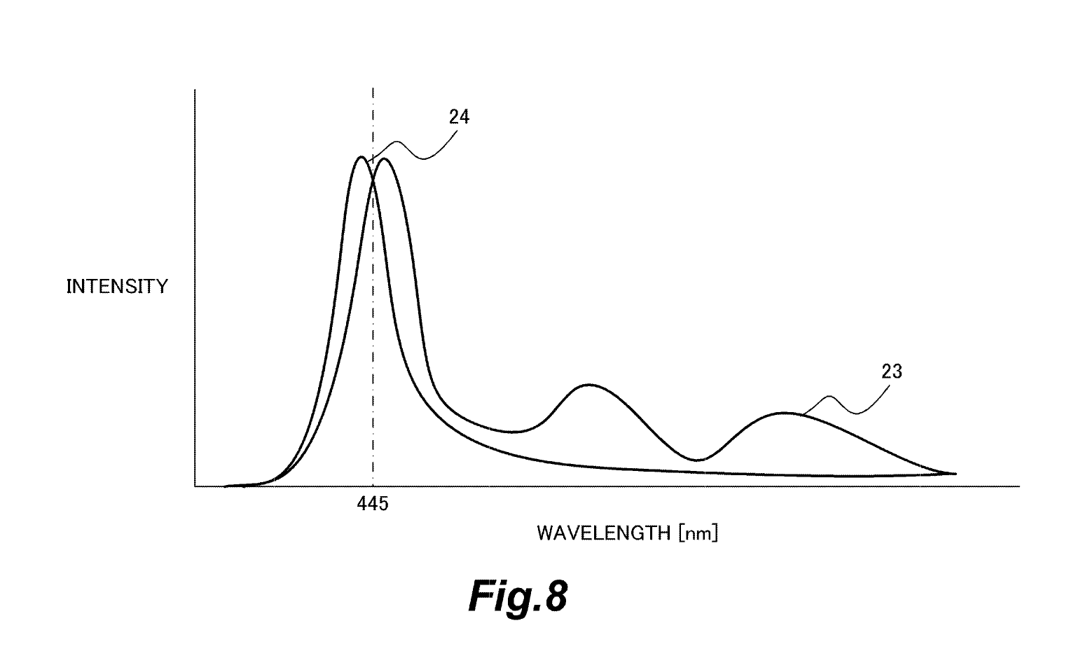

FIG. 8 is a diagram depicting a spectral characteristic 23 of a light source 11 and a spectral characteristic 24 of a light source 12 in a backlight according to Embodiment 3 of the present invention.

Embodiment 3 has a light source configuration similar to the light source configuration of Embodiment 1 but is different from Embodiment 1 in the spectral characteristic of each light source. As depicted in FIG. 8, the light source 11 is a LED that emits blue light with a dominant wavelength within a first wavelength range. The LED excites green light with a dominant wavelength within a second wavelength range and red light with a dominant wavelength within a third wavelength range. Furthermore, the light source 12 is a LED that emits blue light with a dominant wavelength within the first wavelength range.

In Embodiment 3, a peak wavelength within the first wavelength range of blue light emitted by the LED of the light source 11 is different from a peak wavelength within the first wavelength range of blue light emitted by the LED of the light source 12. Furthermore, a composite spectral characteristic resulting from addition of the spectral characteristics of the light source 11 and the light source 12 has a peak wavelength of 445 nm.

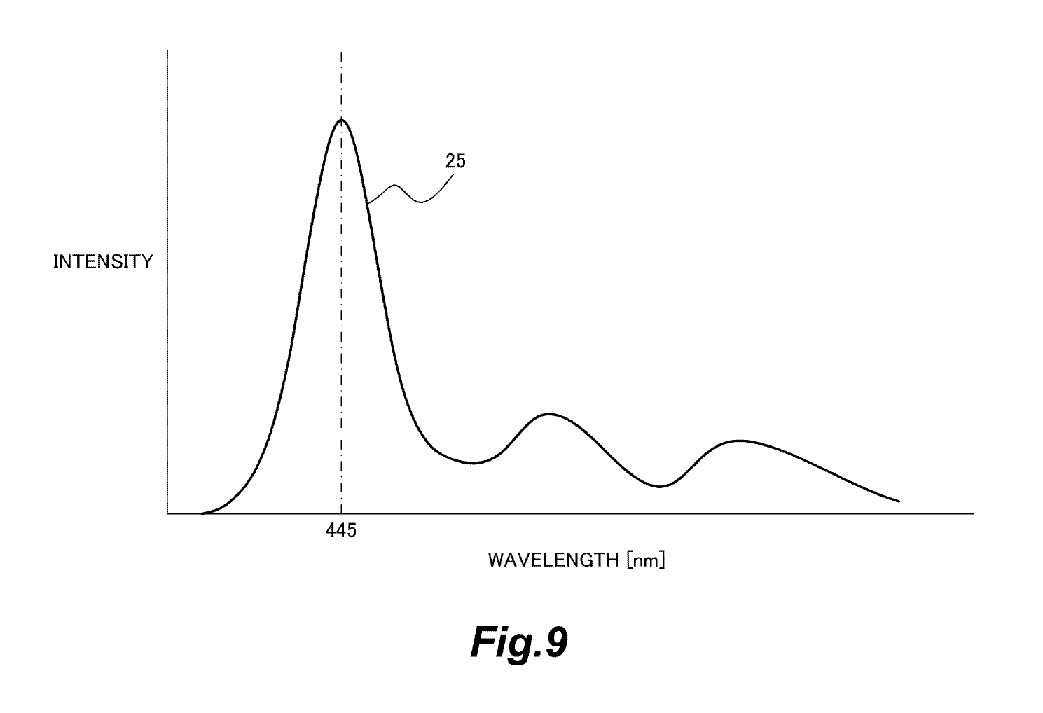

FIG. 9 depicts the composite spectral characteristic resulting from addition of the spectral characteristics of the light source 11 and the light source 12 configured as described above. As depicted in FIG. 9, the composite spectral characteristic 25 resulting from addition of the spectral characteristics of the light source 11 and the light source 12 has a broad shape with a peak at 445 nm. This provides a backlight with suppressed individual differences in the manner of sensing colors.

In Embodiment 3, the blue light source of the light source 12 does not excite light of the longer-wavelength-side color, and thus, the blue light source has an increased light emission efficiency. Hence, a backlight can be provided which needs reduced power consumption and which serves to suppress differences in the manner of sensing colors.

In Embodiment 3, the first light source 11 and the second light source 12 both have a spectral characteristic of blue light with an emission light peak or an excitation light peak within the first wavelength range. The first light source 11 further has a spectral characteristic of at least one of green light with an emission light peak or an excitation light peak within the second wavelength range and red light with an emission light peak or an excitation light peak within the third wavelength range. Specifically, the first light source 11 has an emission light peak within the first wavelength range and excitation light peaks within the second wavelength range and within the third wavelength range. The second light source 12 has an emission light peak within the first wavelength range. The peak within the first wavelength range of the first light source 11 is different, in peak wavelength, from the peak wavelength of the peak within the first wavelength range of the second light source 12. One of the peaks has a wavelength on a longer wavelength side with respect to a predetermined peak wavelength (445 nm±2 nm). The other peak has a wavelength on a shorter wavelength side with respect to the peak wavelength. A composite spectral characteristic resulting from light emissions from the first light source 11 and the second light source 12 has peaks within the first wavelength range, within the second wavelength range, and within the third wavelength range. The peak within the first wavelength range has a larger half-value width than each of the peaks within the other wavelength ranges. Moreover, the peak within the first wavelength range has a substantially symmetric shape around the peak wavelength. The spectral characteristic within the first wavelength range can have a broad shape even in a configuration in which the peak within the first wavelength range of the first light source is substantially equal, in peak wavelength, to and is different, in half-value width, from the peak within the first wavelength range of the second light source.

The present invention is not limited to the above-described embodiments but many variations may be made to the embodiments. For example, the dominant wavelengths of the light sources and phosphors may be selected so that a spectral characteristic having a peak with a predetermined peak wavelength of 445 nm corresponding to a dominant wavelength is implemented at a desired brightness and a desired temperature. Furthermore, on the assumption that the brightness of the backlight may be changed by user adjustment or the like, the dominant wavelength of the light sources may be selected with a possible change in the dominant wavelength in a usage environment pre-assumed so as to allow a change in the brightness of LEDs to be dealt with. Moreover, the arrangement of the light sources 11 and the light source 12 may be changed in accordance with the specification of a diffuse structure. Alternatively, the light sources 11 and the light sources 12 may be arranged at the periphery of a screen as in a diffuse structure that uses a light guide plate.

In the embodiments, the example has been described where the present invention is applied to a display apparatus that is a transmissive liquid crystal panel. However, the preset invention is not limited to the same. The display apparatus may be any display apparatus with an independent light source. For example, the display apparatus may be a MEMS shutter display that uses a MEMS (Micro Electro Mechanical System) shutter.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to readout and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2014-012642, filed on Jan. 27, 2014, which is hereby incorporated by reference herein in its entirety.

What is claimed is:

1. A light emitting apparatus comprising a first light source and a second light source, wherein
both the first light source and the second light source have a spectral characteristic of blue light having an emission light peak or an excitation light peak within a predetermined first wavelength range,
at least one of the first light source and the second light source further has a spectral characteristic of at least one of green light having an emission light peak or an excitation light peak within a predetermined second wavelength range and red light having an emission light peak or an excitation light peak within a predetermined third wavelength range, and
a composite spectral characteristic resulting from light emissions from both the first light source and the second light source has peaks within the first wavelength range, within the second wavelength range, and within the third wavelength range, the peak within the first wavelength range has a larger half-value width than those of the peaks in the other wavelength ranges, and the peak within the first wavelength range has a substantially symmetric shape about the peak wavelength.

2. The light emitting apparatus according to claim 1, wherein the peak within the first wavelength range of the composite spectral characteristic has a predetermined peak wavelength.

3. The light emitting apparatus according to claim 2, wherein the predetermined peak wavelength is 445 nm±2 nm.

4. The light emitting apparatus according to claim 1, wherein the peak within the first wavelength range of the first light source is different, in peak wavelength, from the peak within the first wavelength range of the second light source.

5. The light emitting apparatus according to claim 2, wherein the peak within the first wavelength range of the first light source is different, in peak wavelength, from the peak within the first wavelength range of the second light source, one of the peaks has a wavelength on a longer wavelength side with respect to the predetermined peak wavelength, and the other peak has a wavelength on a shorter wavelength side with respect to the predetermined peak wavelength.

6. The light emitting apparatus according to claim 1, wherein the peak within the first wavelength range of the first light source is different, in half-value width, from the peak within the first wavelength range of the second light source.

7. The light emitting apparatus according to claim 1, wherein the peak within the first wavelength range of the first light source is substantially equal, in peak wavelength, to and is different, in half-value width, from the peak within the first wavelength range of the second light source

8. The light emitting apparatus according to claim 1, wherein
the first light source emits blue light with a peak within the first wavelength range, and the blue light excites green light with a peak within the second wavelength range, and
the second light source emits blue light with a peak within the first wavelength range, and the blue light excites red light with a peak within the third wavelength range.

9. The light emitting apparatus according to claim 1, wherein
the first light source emits ultraviolet light with a peak within a predetermined fourth wavelength range, and the ultraviolet light excites blue light with a peak within the first wavelength range, and
the second light source emits blue light with a peak within the first wavelength range, and the blue light excites green light with a peak within the second wavelength range and red light with a peak within the third wavelength range.

10. The light emitting apparatus according to claim 1, wherein
the first light source emits blue light with a peak within the first wavelength range, and the blue light excites green light with a peak within the second wavelength range and red light with a peak within the third wavelength range, and
the second light source emits blue light with a peak within the first wavelength range.

11. A backlight apparatus comprising the light emitting apparatus according to claim 1.

12. A display apparatus comprising the backlight apparatus according to claim 11 and a display panel that displays an image by adjusting a transmittance for light from the backlight apparatus.

13. The display apparatus according to claim 12, wherein each pixel in the display panel comprises color filters for at least blue, green, and red, and transmitted light from the display panel is turned into white light by adjusting the transmittance for each of the color filers.
